(19) United States
(12) Patent Application Publication
(10) Pub. No.: US 2010/0165006 A1
(43) Pub. Date: Jul. 1, 2010

(54) DISPLAY DEVICE HAVING CURRENT LIMIT FUNCTION

(76) Inventor: Ho-Yong Son, Yongin-si (KR)

Correspondence Address: SHERR & VAUGHN, PLLC, 620 HERNDON PARKWAY, SUITE 320, HERNDON, VA, 20170, US

(21) Appl. No.: 12/648,219

(22) Filed: Dec. 28, 2009

(30) Foreign Application Priority Data
Dec. 29, 2008 (KR) 10-2008-0135287

(51) Int. Cl. G09G 5/10

(52) U.S. Cl. 345/690

(57) ABSTRACT

A display device and methods thereof. A display device may include a current limit control signal generator to output a current limit control signal according to an input display data, a RGB common gamma adjuster to adjust a value of a RGB common gamma setting signal input via a current limit control signal, a gamma divider to divide a RGB common gamma setting signal having a value adjusted by a RGB common gamma adjuster, and/or a gray amplifier to output a gray signal to drive a display screen by amplifying a signal divided by a gamma divider. A display device may have an automatic current limit function applicable to substantially all kinds of display screen, substantially without additional circuits for data calculation.

The present application claims priority under 35 U.S.C. 119 to Korean Patent Application No. 10-2008-0135287 (filed on Dec. 29, 2008) which is hereby incorporated by reference in its entirety.

### BACKGROUND

Embodiments relate to a display device and a method thereof. Some embodiments relate to a display device which may include a current limit function.

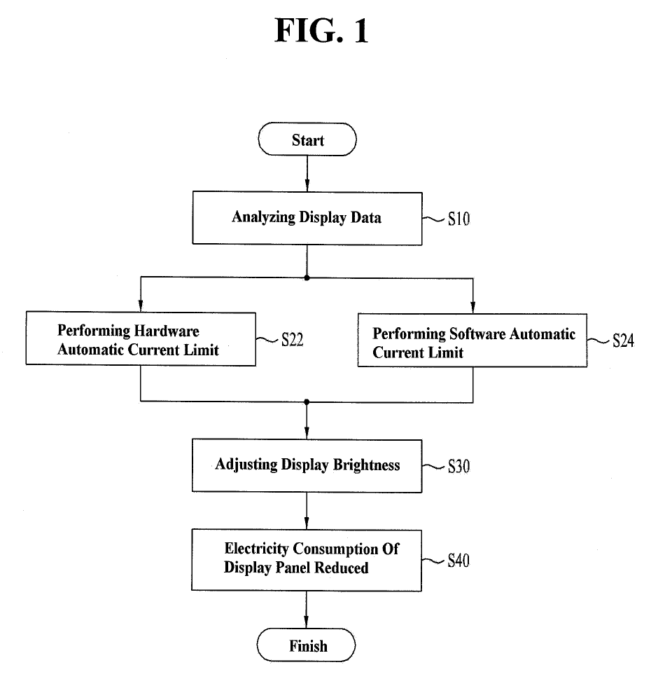

An automatic current limit function of a display device may perform analysis work, for example, calculating an average value of brightness with respect to input display data in a predetermined interval. An automatic current limit function may perform automatic current limit for hardware and/or software based on a result of a calculation. Referring to example FIG. 1, input display data may be analyzed (S10), hardware automatic current limit may be performed (S22) and/or software automatic current limit may be performed (S24) based on a result of an analysis.

In hardware automatic current limit (S22), a screen display may be on and/or off temporally based on a result of an analysis of display data. In software automatic current limit (S24), a size of data may be adjusted during a driving of display data in a display screen based on a result of an analysis of display data. An adjusting of data size may include reducing an overall size of display data to a predetermined value and/or multiplying a size of display data by a predetermined coefficient to generate another adjustment value according to data size. As hardware automatic current limit (S22) and/or a software automatic current limit (S24) may be performed, display brightness may be adjusted (S30) and/or consumed current of a display panel may be relatively reduced because of adjusted brightness (S40).

According to a hardware automatic current limit of a display device, it may be necessary to turn on and/or off a display screen based on adjustment of a driver integrated circuit. A relatively higher cost may be required to fabricate a display screen. In a display screen not having such a function, it may not be substantially possible to represent a hardware automatic current limit itself. In addition, a software automatic current limit may be represented by a function of a driver integrated circuit regardless of a structure of a display screen. However, when a display data may be driven to a screen, an amount of calculation circuits may be required for data conversion. The higher resolution of a screen may be, the relatively faster an input interval of data may be. Therefore, a calculation process may require additional control methods and/or calculation circuits because of a relatively faster input/output.

Accordingly, there is a need of a display device, and methods thereof, which may include an automatic current limit function relatively smoothly applicable to substantially all kinds of display screens, for example substantially without any additional circuits for data calculation.

### SUMMARY

Embodiments relate to a display device, and methods thereof. According to embodiments, a display device may include an automatic current limit function relatively smoothly applicable to substantially all kinds of display screens, for example substantially without any additional circuits for data calculation.

According to embodiments, a display device may include a current limit control signal generator to output a current limit control signal according to an input display data. In embodiments, a display device may include a RGB common gamma adjuster to adjust a value of a RGB common gamma setting signal input via a current limit control signal. In embodiments, a display device may include a gamma divider to divide a RGB common gamma setting signal having a value adjusted by a RGB common gamma adjuster. In embodiments, a display device may include a gray amplifier to output a gray signal to drive a display screen by amplifying a signal divided by a gamma divider.

According to embodiments, a current limit control signal generator may output a current limit control signal having a value distinguished according to gamma gray regions of display data by analyzing display data. In embodiments, a current limit control signal generator may output a current limit control signal by measuring average brightness of a display screen according to a gray region of display data. In embodiments, a RGB common gamma adjuster may adjust a value of a gamma setting signal according to a gamma gray region of display data via a current limit control signal. In embodiments, a gamma divider may include a serially connected resistance array to divide a adjusted RGB common gamma setting signal into plural levels. In embodiments, a gamma divider may receive a current limit control signal and/or a gamma divider may divide a adjusted RGB common gamma setting signal into plural levels according to a control of a current limit control signal.

According to embodiments, a display device may include a current limit control signal generation circuit to generate a current limit control signal for each RGB according to an input display data. In embodiments, a display device may include a gamma adjustment circuit for each RGB to adjust a gamma setting signal for each RGB inputted via a current limit control signal for each RGB. In embodiments, a display device may include a gamma division circuit to divide a gamma setting signal for each RGB by a gamma adjustment circuit for each RGB. In embodiments, a display device may include a gray amplification circuit to output a gray signal for each RGB to drive a display screen by amplifying a signal divided by a gamma division circuit.

According to embodiments, a current limit control signal generation circuit may output a current limit control signal for each RGB having a different value according to gamma gray region for each RGB of display data by analyzing display data according to each RGB. In embodiments, a current limit control signal generation circuit may output a current limit control signal for each RGB by measuring average brightness of a display screen according to a gamma gray region for each RGB of display data. In embodiments, a gamma adjustment circuit for each RGB may adjust a value of a gamma setting signal for each RGB according to a gamma gray region for each RGB of display data via a current limit control signal for each RGB. In embodiments, a gamma division circuit may include a plurality of serially connected resistance arrays to divide adjusted RGB gamma setting signals into plural levels. In embodiments, a gamma division circuit may receive a current limit control signal for each RGB and/or a gamma division circuit may divide an adjusted RGB gamma setting signals into plural levels according to a control of a current limit control signal for each RGB.

According to embodiments, a display device may be able to adjust gamma based on a result of an analysis of display data. In embodiments, a display device may be relatively smoothly applicable to substantially all kinds of display screens. In embodiments, a display device may be able to adjust gamma based on a result of a display data analysis. In embodiments, a display device may represent a automatic current limit function substantially without any structural change of a display screen and/or any additional circuits. In embodiments, a display device may control current limit for each gamma gray region and/or each color. In embodiments, an effect of versatile brightness conversion for each gamma gray region and/or each color may be maximized.

### DRAWINGS

Example FIG. 1 is a flow chart illustrating a automatic current limit of a display device.

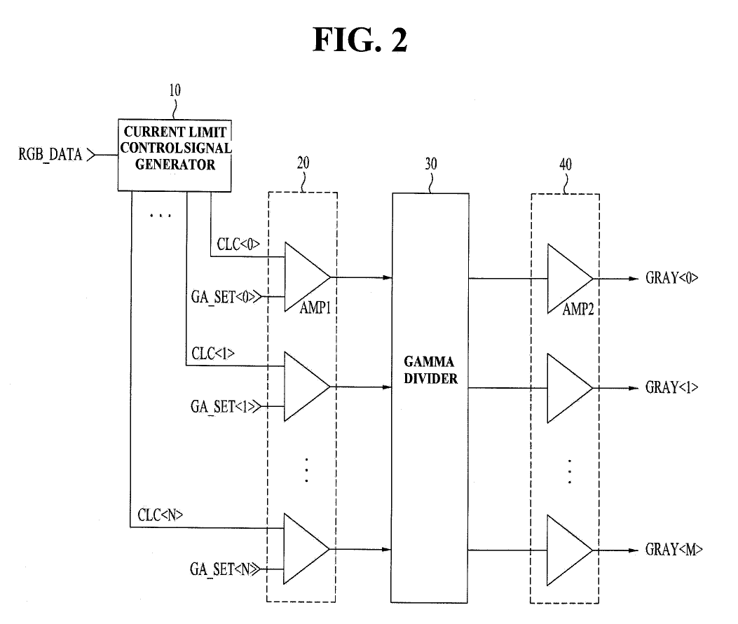

Example FIG. 2 is a block view illustrating a display device in accordance with embodiments.

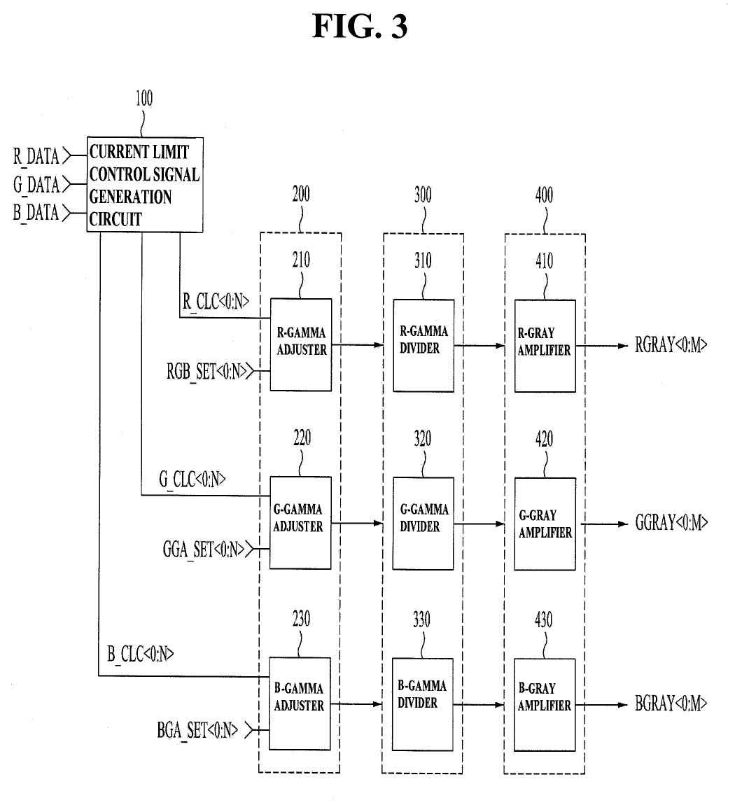

Example FIG. 3 is a block view illustrating a display device in accordance with embodiments.

### DESCRIPTION

Embodiments relate to a display device, and methods thereof. According to embodiments, a display device may be able to analyze input display data and/or to adjust gamma based on a result of an analysis to minimize electricity consumption. Referring to example FIG. 2, a display device is illustrated in accordance with embodiments. According to embodiments, a display device may include current limit control signal generator 10, RGB common gamma adjuster 20, gamma divider 30 and/or a gray amplifier 40.

According to embodiments, current limit control signal generator 10 may receive input display data RGB_DATA and/or may generate current limit control signal CLC<0:N>. In embodiments, current limit control signal generator 10 may analyze display data RGB_DATA to output a current limit control signal having a value distinguished according to a gamma gray region of display data RGB_DATA, and/or may measure an average brightness of a display screen according to a gamma gray region of display data RGB_DATA to output current limit control signal CLC<0:N>. In embodiments, a gamma gray region of display data RGB_DATA may reference a region having a different gamma curve.

According to embodiments, RGB common gamma adjuster 20 may adjust a value of RGB common gamma setting signal GA_SET<0:N> input via current limit control signal CLC<0:N>. In embodiments, RGB common gamma adjuster 20 may include a plurality of amplifiers AMP1 controlled by current limit control signal CLC<0:N> and/or RGB common gamma setting signal GA_SET<0:N>. In embodiments, RGB common gamma adjuster 20 may adjust a value of gamma setting signal GA_SET<0:N> according to a gamma gray region of display data RGB_DATA via current limit control signal CLC<0:N>.

According to embodiments, gamma divider 30 may divide RGB common gamma setting signal having a value adjusted by RGB common gamma adjuster 20, and/or may include a resistance array having a serial structure to divide an adjusted RGB common gamma setting signal into plural levels. In embodiments, gamma divider 30 may receive more input current control signal CLC<0:N> and/or may divide an adjusted RGB common gamma setting signal into plural levels according to control of current limit control signal CLC<0:N>. In embodiments, gamma divider 30 may include a serially connected resistance array. In embodiments, an adjusted RGB common gamma setting signal may be divided, and/or a resistance value divided by current limit control signal CLC<0:N> may be adjusted.

According to embodiments, gray amplifier 40 may amplify a signal divided by gamma divider 30 and/or may output gray signal GRAY<0:M> to drive a display screen. In embodiments, gray amplifier 30 may amplify and/or may include a plurality of amplifiers AMP2 to output gray signal GRAY<0:M> by amplifying a divided signal. In embodiments, a display device may adjust gamma based on a result of an analysis of input display data RGB_DATA. In embodiments, driving of a display screen may be adjusted via an adjusted gamma. In embodiments, electricity consumption may be minimized when a screen may be displayed.

According to embodiments, different adjusted values, for example current limit control signals CLC<0:N>, may be input to RGB common gamma adjuster 20. In embodiments, an adjustment effect distinguished according to gamma gray regions of display data RGB_DATA may be created. In embodiments, different adjusted values, for example current limit control signals CLC<0:N>, may be input to gamma divider 30. In embodiments, substantially more minute gray region distinguishment application effect may be created.

Referring to example FIG. 3, a display device may include current limit control signal generation circuit 100, RGB gamma adjustment circuit 200, gamma division circuit 300 and/or gray amplification circuit 400. According to embodiments, current limit control generation circuit 100 may receive input display data R_DATA corresponding to red and/or may output current limit control signal R_CLC<0:N>. In embodiments, current limit control generation circuit 100 may receive input display data G_DATA corresponding green and/or may output current limit control signal G_CLC<0:N>. In embodiments, current limit control generation circuit 100 may receive input display data B_DATA corresponding to blue and/or may output current limit control signal B_CLC<0:N>.

According to embodiments, current limit control signal generation circuit 100 may analyze each display data, for example R_DATA, G_DATA and/or B_DATA. In embodiments, current limit control signal generation circuit 100 may measure an average brightness of a display screen according to gamma gray regions of R_DATA, G_DATA and/or B_DATA, to output current limit control signals for RGBs having values distinguished according to gamma gray regions of R_DATA, G_DATA and/or B_DATA.

According to embodiments, RGB gamma adjustment circuit 200 may include R-gamma adjuster 210, G-gamma adjuster 220 and/or B-gamma adjuster 230. In embodiments, R-gamma adjuster 210 may adjust a value of a gamma setting signal corresponding to red, for example RGA_SET<0:N>, which may be input via current limit control signals, for example R_CLC<0:N>. In embodiments, R-gamma adjuster 220 may adjust a value of a gamma setting signal corresponding to green, for example GGA_SET<0:N>, which may be input via current limit control signal, for example G_CLC<0:N>. In embodiments, B-gamma adjuster 230 may adjust a value of gamma setting signal corresponding to blue, for example BGA_SET<0:N>, input via current limit control signal, for example B_CLC<0:N>. In embodiments, RGB gamma adjustment circuit 200 may adjust each value of RGB gamma setting signals RGA_SET<0:N>, GGA_SET<0:N> and/or BGA_SET<0:N>, according to gamma gray regions of display data R_DATA, G_DATA and/or B_DATA, via current limit control signals for each RGB R_CLC<0:N>, G_CLC<0:N> and/or B_CLC<0:N>.

According to embodiments, gamma division circuit 300 may include R-gamma divider 310 to divide a gamma setting signal having its value adjusted by R-gamma adjuster 210, G-gamma divider 320 to divide a gamma setting signal having its value adjusted by G-gamma adjuster 220 and/or B-gamma divider 330 to divide gamma setting signal having its value adjusted by B-gamma adjuster 230. In embodiments, each gamma divider 310, 320 and/or 330 may include a serially connected resistance array to divide gamma setting signals adjusted by gamma adjusters 210, 220 and/or 230 into plural levels. In embodiments, gamma dividers 310, 320 and/or 330 may receive input current limit control signals R_CLC<0:N>, G_CLC<0:N> and/or B_CLC<0:N>, and/or may divide gamma setting signals adjusted by gamma adjusters 210, 220 and/or 230 into plural levels according to a control of current limit control signals R_CLC<0:N>, G_CLC<0:N> and/or B_CLC<0:N>.

According to embodiments, a gray amplification circuit may include R-gray amplifier 410 to output gray signal RGRAY<0:M> by amplifying a signal divided by R-gamma divider 310, G-gray amplifier 420 to output gray signal GGRAY<0:M> by amplifying a signal divided by G-gamma divider 320 and/or B-gray amplifier 430 to output a gray signal BGRAY<0:M> by amplifying a signal divided by B-gamma divider 330. In embodiments, a display device may gain an effect of brightness adjustment for each color by applying current adjustment values different for corresponding colors.

It will be obvious and apparent to those skilled in the art that various modifications and variations can be made in the embodiments disclosed. Thus, it is intended that the disclosed embodiments cover the obvious and apparent modifications and variations, provided that they are within the scope of the appended claims and their equivalents.

What is claimed is:

1. An apparatus comprising:
a current limit control signal generator configured to output a current limit control signal according to input display data;
a RGB common gamma adjuster configured to adjust a value of a RGB common gamma setting signal input through said current limit control signal;
a gamma divider configured to divide said RGB common gamma setting signal having a value adjusted by said RGB common gamma adjuster; and
a gray amplifier configured to output a gray signal to drive a display screen by amplifying said signal divided by said gamma divider.

2. The apparatus of claim 1, wherein said current limit control signal generator is configured to output said current limit control signal having a value distinguished according to gamma gray regions of said display data by analyzing said display data.

3. The apparatus of claim 1, wherein said current limit control signal generator is configured to output said current limit control signal by measuring average brightness of said display screen according to a gray region of said display data.

4. The apparatus of claim 1, wherein said RGB common gamma adjuster is configured to adjust a value of said gamma setting signal according to a gamma gray region of said display data through said current limit control signal.

5. The apparatus of claim 1, wherein said gamma divider comprises a serially connected resistance array configured to divide said adjusted RGB common gamma setting signal into plural levels.

6. The apparatus of claim 1, wherein said gamma divider is configured to receive said current limit control signal and said gamma divider is configured to divide said adjusted RGB common gamma setting signal into plural levels according to a control of said current limit control signal.

7. The apparatus of claim 1, comprising a display device.

8. An apparatus comprising:
a current limit control signal generation circuit configured to generate a current limit control signal for each RGB according to input display data;
a gamma adjustment circuit for each RGB configured to adjust a gamma setting signal for each RGB input through said current limit control signal for each RGB;
a gamma division circuit configured to divide said gamma setting signal for each RGB by said gamma adjustment circuit for each RGB; and
a gray amplification circuit configured to output a gray signal for each RGB to drive a display screen by amplifying said signal divided by said gamma division circuit.

9. The apparatus of claim 8, wherein said current limit control signal generation circuit is configured to output a current limit control signal for each RGB having a different value according to a gamma gray region for each RGB of said display data by analyzing said display data according to each RGB.

10. The apparatus of claim 8, wherein said current limit control signal generation circuit is configured to output said current limit control signal for each RGB by measuring average brightness of said display screen according to gamma gray regions for each RGB of said display data.

11. The apparatus of claim 8, wherein said gamma adjustment circuit for each RGB is configured to adjust a value of a gamma setting signal for each RGB according to a gamma gray region for each RGB of said display data through said current limit control signal for each RGB.

12. The apparatus of claim 8, wherein said gamma division circuit comprises a plurality of serially connected resistance arrays configured to divide said adjusted RGB gamma setting signals into plural levels.

13. The apparatus of claim 8, wherein said gamma division circuit is configured to receive said current limit control signal for each RGB and said gamma division circuit is configured to divide said adjusted RGB gamma setting signals into said plural levels according to a control of said current limit control signal for each RGB.

14. The apparatus of claim 8, comprising a display device.

15. A method comprising:
a current limit control signal generator outputting a current limit control signal according to input display data;
a RGB common gamma adjuster adjusting a value of a RGB common gamma setting signal input through said current limit control signal;
a gamma divider dividing said RGB common gamma setting signal having a value adjusted by said RGB common gamma adjuster; and
a gray amplifier outputting a gray signal driving a display screen by amplifying said signal divided by said gamma divider.

16. The method of claim 15, wherein said current limit control signal generator outputs said current limit control signal having a value distinguished according to gamma gray regions of said display data by analyzing said display data.

17. The method of claim 15, wherein said current limit control signal generator outputs said current limit control signal by measuring average brightness of said display screen according to a gray region of said display data.

18. The method of claim 15, wherein said RGB common gamma adjuster adjusts a value of said gamma setting signal according to a gamma gray region of said display data through said current limit control signal.

19. The method of claim 15, wherein said gamma divider comprises a serially connected resistance array dividing said adjusted RGB common gamma setting signal into plural levels.

20. The method of claim 15, wherein said gamma divider receives said current limit control signal and said gamma divider divides said adjusted RGB common gamma setting signal into plural levels according to a control of said current limit control signal.
